(19) United States
(12) Patent Application Publication
(10) Pub. No.: US 2005/0180759 A1
(43) Pub. Date: Aug. 18, 2005

(54) Cordless laser power meter

(76) Inventors: Alex Gusev, Bowling Green, OH (US); Nikolay Kokarev, Bowling Green, OH (US)

Correspondence Address: FRASER MARTIN BUCHANAN MILLER LLC, 132C WEST SECOND STREET, PERRYSBURG, OH, 43551-1401, US

(21) Appl. No.: 11/053,144

(22) Filed: Feb. 8, 2005

Related U.S. Application Data
(60) Provisional application No. 60/545,731, filed on Feb. 18, 2004.

(51) Int. Cl. H04B 10/04

(52) U.S. Cl. 398/182

(57) ABSTRACT

A cordless laser power meter consists of a photodetector and power meter module. The photodetector unit includes a power sensor for converting the voltage from the power sensor to a radio signal and a radio transmitter. The power sensor output provides voltage which is converted and sent to a power meter module by a radio transmitter. The power meter module includes a radio receiver and converts the voltage signal from the photodetector into the laser power display to show the measured laser power.

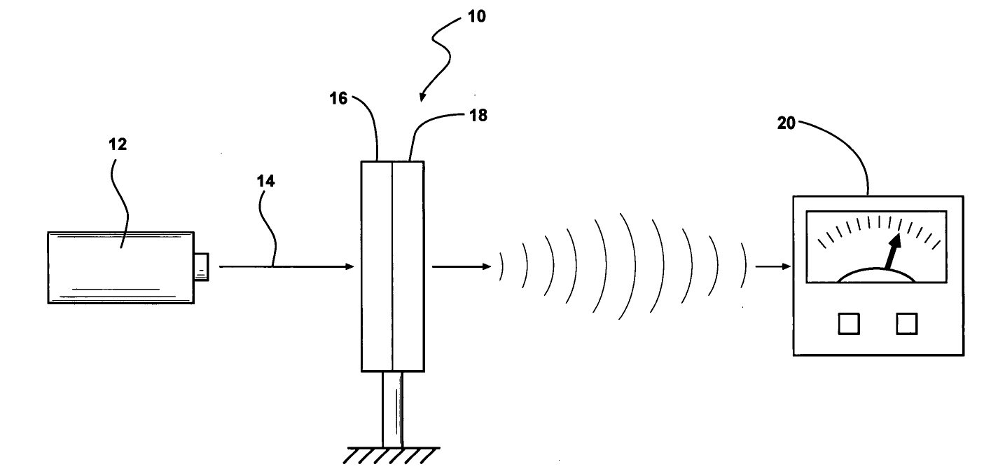

### CROSS-REFERENCE TO RELATED APPLICATION

This application claims the benefit of U.S. provisional patent application Ser. No. 60/545,731 filed Feb. 18, 2004.

### BACKGROUND OF THE INVENTION

1. Field of the Invention

The present invention relates generally to a system for sensing the power output of a laser and, more particularly, to a system for sensing the power output of a laser wherein the display of the power is disposed remotely of the laser power sensor.

2. Description of the Prior Art

The measurement of the power output of a laser is essential for many applications. These applications include military use, and medical use wherein the relative location of the power sensor and the display unit are required to be varied. Since the measuring device is typically coupled to the display unit, limitations are imposed on the system by the length and complexity of the interconnecting electrical conductor.

Laser power meters of the type known in the prior art are illustrated and described in U.S. Pat. Nos. 3,596,514; 3,783,685; 3,918,303; 4,037-470; 4,440,506; 4,865,446; and 5,523,837.

The prior art discloses various types of systems for sensing the power output of a laser. However there is no disclosure of a cordless laser power meter of the present invention.

### SUMMARY OF THE INVENTION

An object of the present invention is to produce a cordless laser power meter wherein the position of the individual components may be readily and easily adjusted relative to one another without the inherent limitations of an electrical conductor.

Another object of the present invention is to produce a cordless laser power meter which includes a photodetector module and a laser power display module wherein the distance between the modules may be easily varied without the inherent limitation of an electrical conductor of a finite length.

Still another object of the present invention is to -produce a cordless laser power meter which eliminates accidents related to the repositioning of the individual components including cord burns and damaged optics.

The above objectives may be typically achieved by a system for sensing the power output of a laser comprising a laser generating a beam of electromagnetic radiation along a path; a radiation detector positioned to sense the beam of electromagnetic radiation generated by the laser, the detector including a transmitter for transmitting a radio frequency signal corresponding to power of the radiation sensed by the detector; and a receiver for receiving the signal transmitted by the transmitter of the detector to display the power output of the laser.

### BRIEF DESCRIPTION OF THE DRAWINGS

The above objects and advantages of the invention will become readily apparent to those skilled in the art from reading the following detailed description of a preferred embodiment of the invention when considered in the light of the accompanying drawing, which discloses an embodiment of a cordless laser power meter incorporating the features of the present invention.

### DETAILED DESCRIPTION OF THE PREFERRED EMBODIMENT

Referring to the drawing, there is illustrated a cordless laser power meter 10 for measuring the output of a laser 12 capable of producing a laser beam 14. The power meter 10 consists of a photodetector unit 16 which includes a power sensor which may be thermal, photodiode, or pyroelectric suitable for sensing the laser beam 14 and producing a voltage signal proportional to the power of the impinging laser beam 14.

The voltage signal produced thereby is sensed by an associated transmitter 18 and converted to a radio frequency signal. The transmitter 18 may be typically energized by a rechargeable battery, for example.

The transmitted signal is then received by a remotely situated properly tuned power meter module 20. The module 20 includes a radio frequency signal receiver having electronics suitable for converting the received signal from the transmitter 18 into an integral display unit to show the measured laser power.

In addition to the above-described analog system for transmitting the signal from the transmitter 18 to the power meter module 20, it will be understood that a digital system could likewise be employed. In such a system, a digitizer could be incorporated into a photodetector module, for example. A complete system would therefore comprise a laser generating a beam of electromagnetic radiation, a photodetector positioned to sense the beam of light generated by the laser, the digitizer to convert the analog photodetector voltage output into a digital signal, a transmitter for wirelessly transmitting a digital electromagnetic signal corresponding to the laser power sensed by the photodector; and a receiver for receiving the wireless signal transmitted by the transmitter of the detector to display the power output of the laser. Accordingly, the system can function in a digital mode as well as an analog mode.

It will be appreciated that the above-described invention provides for easy positioning of the power meter module 20 relative to the photodetector unit 16 without the requirement of repositioning an associated electrical power cord.

Another advantage which is inherent in the novel system is the distance between the respective components which may be varied very easily since there is no limitation dictated by the length of an electrical power cord.

Satisfactory results may be achieved by utilizing the following parameters:

| | |
|---|---|
| Laser 12 | Millennia Pro 5s |
| | (Spectra Physics) |
| Photodector 16 | P/N 1Z02637 |
| | (Ophir Optronics Ltd.) |
| Transmitter 18 | X-12 Digital Transmitter |
| | (Mortara Instrument) |
| Power Meter 20 | P/N 1Z01500 |
| | (Ophir Optronics Ltd.) |

Since there is no requirement for an electrical cord, accidents which might otherwise occur are eliminated. Such accidents heretofore involved cord burns and damaged optics. These problems are oftentimes very expensive and may create smoke which could damage optical coatings and result in equipment failure. Obviously, should such happenstances occur, repositioned optics could direct the laser beam reflections into the eyes of the operator resulting in loss of eyesight.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A system for sensing the power output of a laser generating a beam of electromagnetic radiation along a path comprising:
a radiation detector positioned to sense the beam of electromagnetic radiation generated by the laser, said detector including a transmitter for transmitting a radio frequency signal corresponding to energy of the radiation sensed by said detector; and
a receiver for receiving the signal transmitted by said detector to display the power output of the laser.
